(19) United States
(12) Patent Application Publication
(10) Pub. No.: US 2013/0265688 A1
(43) Pub. Date: Oct. 10, 2013

(54) ELECTRONIC DEVICE AND ANTI-STATIC PROTECTION CIRCUIT FOR SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: Xing-Hua TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/848,676

(22) Filed: Mar. 21, 2013

(30) Foreign Application Priority Data
Apr. 5, 2012 (CN) 201210097101.6

(51) Int. Cl. H05F 3/04

(52) U.S. Cl. CPC H05F 3/04
USPC 361/220

(57) ABSTRACT

An anti-static protection circuit includes a first discharge unit and a second discharge unit. The first discharge unit is connected to a port of an electronic device, and includes a number of first sharp turning points. The first sharp turning points absorb static electricity flowing to the first discharge unit from the port, and discharge part of the static electricity to the air. The second discharge unit is grounded and includes a number of second sharp turning points spaced apart from and directly opposing to the corresponding first sharp turning points of the first discharge unit. The second sharp turning points absorb part of the static electricity on the first sharp turning points, and discharges the part of the static electricity to the ground. A related electronic device employing the protection circuit is also provided.

### BACKGROUND

1. Technical Field

The present disclosure relates to an electronic device and an anti-static protection circuit employed in the electronic device.

2. Description of Related Art

When an electronic device is connected to an external device via its port, external static electricity may flow into the circuit board of the electronic device via the port, and possibly damage electronic components mounted on the circuit board. Protection components are often added between the port and the other electronic components of the electronic device, to discharge static electricity. However, the added external protection components will increase the manufacturing cost of the electronic device, and make the structure of the electronic device complex.

Therefore, what is needed is an electronic device and an anti-static protection circuit to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device, according to an embodiment, the anti-static electronic device includes an anti-static protection circuit and a port.

FIG. 2 is a circuit diagram of the anti-static protection circuit and the port of FIG. 1.

FIG. 3 is a partial layout diagram of the anti-static protection circuit and the port of FIG. 2.

### DETAILED DESCRIPTION

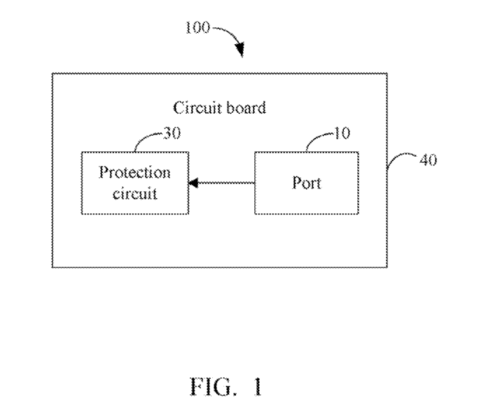

Referring to FIG. 1, an electronic device 100 includes a circuit board 40 and a port 10 and an anti-static protection circuit 30, which are mounted on the circuit board 40. The protection circuit 30 is electrically connected to the port 10, and the protection circuit 30 is configured to protect electronic components (not shown) of the electronic device 100 from external electrostatic damage.

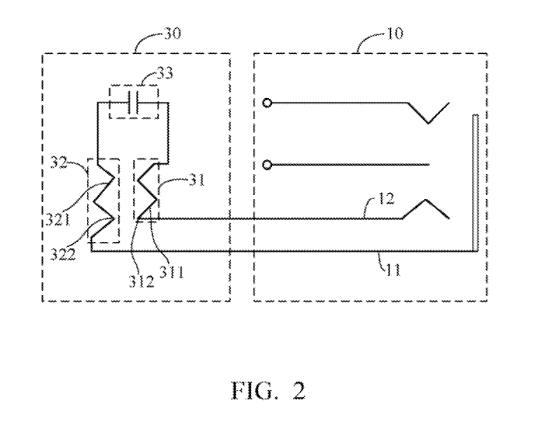

Referring to FIG. 2, the port 10 includes a first pin 11 and a second pin 12. The first pin 11 is grounded, and the first pin 11 and the second pin 12 are connected to the protection circuit 30.

The protection circuit 30 includes a first discharge unit 31, a second discharge unit 32, and a capacitor 33. The first discharge unit 31 is electrically connected between the second pin 12 of the port 10 and one terminal of the capacitor 33, and the second discharge unit 32 is electrically connected between the first pin 11 and the other terminal of the capacitor 33. The first discharge unit 31 has an electric wire 311 arranged in a zigzag fashion, the zigzag electric wire 311 includes a number of first sharp turning points 312 opposing to the second discharge unit 32, and the second discharge unit 32 also has an electric wire 321 arranged in a zigzag fashion, the zigzag electric wire 321 includes a number of second sharp turning points 322 spaced apart from and directly opposing to the corresponding first sharp turning points 312 of the first discharge unit 31.

In use, if external static electricity flows into the electronic device 100 from the second pin 12 of the port 10, the first sharp turning points 312 will absorb static electricity flowing to the first discharge unit 31 and discharge part of the static electricity to the air; and the second sharp turning points 322 of the second discharge unit 32 will absorb part of the static electricity on the first sharp turning points 312 and discharge the part of the static electricity to the ground through the grounded first pin 11; and the remaining static electricity flowing to the capacitor 33 through the first discharge unit 31 and the second discharge unit 32 will be absorbed by the capacitor 33. Thereby, static electricity flowing into the electronic device 100 from the port 10 is reduced or even eliminated, and the electronic components of the electronic device 100 are protected.

In the embodiment, when external static electricity flows to the first discharge unit 31, the first sharp turning points 312 acts to discharge and generates a breakdown current, and the breakdown current is transmitted to ground to be discharged through the second sharp turning points 322.

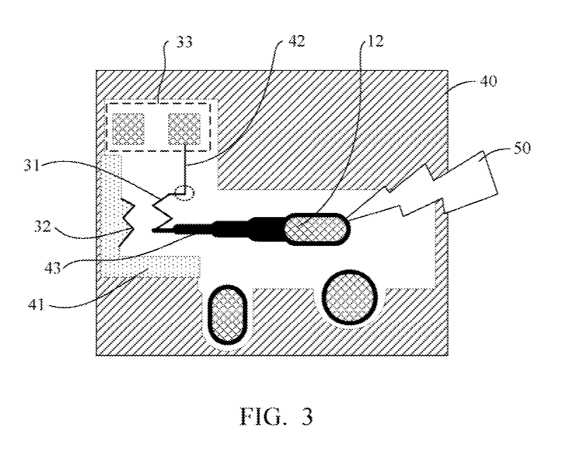

Referring also to FIG. 3, in the embodiment, the circuit board 40 includes a conductive metal layer (not shown) having an exposed portion 41 adjacent to the second discharge unit 32, to facilitate the second discharge unit 32 absorbing the static electricity from the first discharge unit 31.

A transmission line 42 is connected between the first discharge unit 31 and the capacitor 33. In the embodiment, the transmission line 42 is bent, such as being bent to an “L” shape to block the flowing of the static electricity, so as to reduce the amount of the static electricity flowing into the capacitor 33.

A transmission line 43 is connected between the second pin 12 and the first discharge unit 31. In the embodiment, the width of the transmission line 43 is gradedly reduced from the second pin 12 to the first discharge unit 31, to quicken the flow of the static electricity 50 to the first sharp turning points 312 of the first discharge unit 31.

The capacitor 33 absorbs the remaining static electricity which is not discharged by the first discharge unit 31 and the second discharge unit 32. In the embodiment, the capacitor 33 is a non-polar patch capacitor.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a circuit board and a port mounted on the circuit board; and
an anti-static protection circuit electrically connected to the port, the protection circuit comprising:
a first discharge unit having an electric wire arranged in a zigzag fashion, the zigzag electric wire including a plurality of first sharp turning points, a first end of the first discharge unit electrically connected to the port, and the first sharp turning points configured for absorbing static electricity flowing to the first discharge unit from the port and discharging part of the static electricity to the air; and
a second discharge unit having an electric wire arranged in a zigzag fashion, the zigzag electric wire including a plurality of second sharp turning points, the second sharp turning points spaced apart from and directly opposing to the corresponding first sharp turning points of the first discharge unit, a first end of the second discharge unit grounded, and the second sharp turning points configured for absorbing part of the static electricity on the first sharp turning points and discharging the part of the static electricity to the ground.

2. The electronic device as described in claim 1, wherein the protection circuit further comprises a capacitor connected between a second end of the first discharge unit and a second end of the second discharge unit, the capacitor configured to absorb the remaining static electricity which is not discharged by the first discharge unit and the second discharge unit.

3. The electronic device as described in claim 2, wherein the capacitor is a non-polar patch capacitor.

4. The electronic device as described in claim 2, wherein a transmission line is connected between the first discharge unit and the capacitor, and the transmission line is bent to block the flowing of the static electricity, so as to reduce the amount of the static electricity flowing into the capacitor.

5. The electronic device as described in claim 1, wherein the port comprises a first pin and a second pin, wherein the first pin is grounded and connected to the first end of the second discharge unit, and the second pin is connected to the first end of the first discharge unit.

6. The electronic device as described in claim 5, wherein the circuit board includes a conductive metal layer having an exposed portion adjacent to the second discharge unit, to facilitate the second discharge unit absorbing the static electricity from the first discharge unit.

7. The electronic device as described in claim 5, wherein a transmission line is connected between the second pin and the first discharge unit, and the width of the transmission line is gradedly reduced from the second pin to the first discharge unit, to quicken the flow of the static electricity to the first sharp turning points of the first discharge unit.

8. An anti-static protection circuit employed in an electronic device, the protection circuit comprising:
a first discharge unit having an electric wire arranged in a zigzag fashion, the zigzag electric wire including a plurality of first sharp turning points, a first end of the first discharge unit electrically connected to the port, and the first sharp turning points configured for absorbing static electricity flowing to the first discharge unit from the port and discharging part of the static electricity to the air; and
a second discharge unit having an electric wire arranged in a zigzag fashion, the zigzag electric wire including a plurality of second sharp turning points, the second sharp turning points spaced apart from and directly opposing to the corresponding first sharp turning points of the first discharge unit, a first end of the second discharge unit grounded, and the second sharp turning points configured for absorbing part of the static electricity on the first sharp turning points and discharging the part of the static electricity to the ground.

9. The protection circuit as described in claim 8, further comprising a capacitor connected between a second end of the first discharge unit and a second end of the second discharge unit, the capacitor configured to absorb the remaining static electricity which is not discharged by the first discharge unit and the second discharge unit.

10. The protection circuit as described in claim 9, wherein the capacitor is a non-polar patch capacitor.

11. The protection circuit as described in claim 9, wherein a transmission line is connected between the first discharge unit and the capacitor, and the transmission line is bent to block the flowing of the static electricity, so as to reduce the amount of the static electricity flowing into the capacitor.

12. The protection circuit as described in claim 8, wherein the port comprises a first pin and a second pin, wherein the first pin is grounded and connected to the first end of the second discharge unit, and the second pin is connected to the first end of the first discharge unit.

13. The protection circuit as described in claim 12, wherein a transmission line is connected between the second pin and the first discharge unit, and the width of the transmission line is gradedly reduced from the second pin to the first discharge unit, to quicken the flow of the static electricity to the first sharp turning points of the first discharge unit.
